(19) United States
(12) Patent Application Publication
(10) Pub. No.: US 2024/0417583 A1
(43) Pub. Date: Dec. 19, 2024

(54) EFFERVESCENT COLORANT TABLETS

(71) Applicant: SWIMC LLC, Cleveland, OH (US)

(72) Inventor: Taco Scherer, EN Haarlem (NL)

(21) Appl. No.: 18/746,630

(22) Filed: Jun. 18, 2024

Related U.S. Application Data
(60) Provisional application No. 63/508,942, filed on Jun. 19, 2023.

(51) Int. Cl. C09D 17/00; C09D 7/61; C09D 7/63; C09D 7/80; C09D 11/037

(52) U.S. Cl. CPC C09D 17/005; C09D 7/61; C09D 7/63; C09D 7/80; C09D 11/037

(57) ABSTRACT

The present application relates to a colorant tablet comprising: a) at least one pigment; and b) at least one adjuvant. A pigment may be an organic pigment, and inorganic pigment, or combinations thereof. The pigment may be an insoluble pigment. An adjuvant may be a carbonate. The adjuvant may further comprise at least one acid. The colorant tablet may be at least partially dissolved in a solvent (including water) prior to adding to a formulation or directly into a formulation. The formulation may be a coating. A method of forming the colorant tablet is also disclosed.

### FIELD

The present disclosure relates generally to a colorant tablet comprising: a) at least one pigment; and b) at least one adjuvant. The pigment may be an organic pigment, and inorganic pigment, or combinations thereof. The pigment may be an insoluble pigment. An adjuvant may be a carbonate. The adjuvant may further comprise at least one acid. The colorant tablet may be at least partially dissolved in a solvent (including water) prior to adding to a formulation or directly into a formulation. The formulation may be a coating. A method of forming the colorant tablet is also disclosed.

### BACKGROUND

Many coatings require at least one colorant, pigment, or dye in order to provide customers with color options. Typically, these colored coatings formulations, including but not limited to toners, colorants, and other ready-mixed coatings, are provided to customers in a liquid state. These formulations can either be offered to customers in a ready-made colored product or coatings that require an addition of such colorants, pigments, or dyes by addition, dilution, mixing, and/or processing with other paint components to create a final ready-to-use coating product in a desired color. Additionally, these colored coatings must have the appropriate application rheology to coat an object using standard paint application processes like rolling, brushing, spin coating, or spraying without any negative effects from the colorant, pigment, or dye.

Although this approach has been successfully employed for many decades, the transport of these pigments, dyes, and/or colorants in a liquid form for a final ready-to-use coating product contribute to increased shipping costs due to their added solvent weight (from all solvents, including water) and the potential for color separation from the coatings formulation. Also, it may require additional colorant formulation measures (e.g. stabilizing components for colorant stability) to ensure sufficient storage stability for these ready-to-use coating formulations. Accurate dosing is also critical in ensuring that the correct color is achieved.

Further, coatings that require an addition of such colorants, pigments, or dyes by addition, dilution, mixing, and/or processing with other paint components like pigments, dyes, and/or colorants to create a final ready-to-use coating product may have limited storage stability with a finite shelf life. Further, coatings formulated to a particular color must be stored, potentially for long periods of time, until they are needed and must remain stable. An adequate shelf life may require measures such as controlled environmental conditions for colorant shelf-life and separately scheduled mixing for colorant consistency. Additionally, traditional colorants contain solvent (including water), which also increases shipping costs and can contribute to unnecessary waste in these containers.

Further, these standard colorants are often formulated to contain solvents, which contributes to the volatile organic compound (VOC) content of a product. Additionally, other components of standard colorants, such as certain dispersants, may not be compatible with a coating formulation, leading to an inconsistent or splotchy coating.

Although the use of a concentrated liquid paint compositions is not new, it is not commonly practiced in the coatings industry. This may be due to dosing or mixing difficulties of these thick concentrates, instability (e.g., pigment agglomeration, hydrolysis, incorporation issues, or contaminations with microorganism for waterborne concentrates in particular), or ease of use. Although these problems may be overcome by addition or increased levels of appropriate paint additives (e.g., pigment dispersants, stabilizing agents, pH adjustment additives, and/or biocides), it may induce negative final paint performance features such as water sensitive or soft coating films or even harmful levels of biocides that require additional protection measures. Further, thinning these concentrated products with certain solvents may lead to the unfavorable addition of VOC's.

With the use of a concentrated liquid paint, fixed amount of pigments may be supplied by dried ‘pigment press cakes’ or so-called ‘stir-in’ pigments. These substances are typically composed of finely distributed pigment particles together with appropriate dispersants in such a way that pigment agglomeration or reagglomeration is being prevented. Some pigment suppliers do offer these kinds of pigments, but these are not widely accepted by the coatings industry due to compatibility issues between different pigments and the liquid coating, which may ultimately affect the stability of the final product. In addition, these type of pigments concentrates may display poor dissolving capacity, resulting in longer mixing times and/or pigment agglomerations and visible particles (referred to as grit). These issues may ultimately affect the accuracy of the color characteristics, including but not limited to the color strength, hiding power, transparency, and fineness as well as an acceptable coatings appearance.

To overcome these difficulties, it would be advantageous if color can be introduced into a coating by adding fixed quantities of at least one pigment with accurate dosing to the liquid coating with the required paint components and appropriate rheology to ensure easier application and optimal coating film properties. In view of these challenges with many conventional coatings that require the addition of at least one colorant prior to use, the need therefore remains for coatings that can provide consistent and accurate color using fixed amounts of pigment, easier dosing, longer shelf life, more sustainable coatings that may have lower transportation costs, lower VOC's, and other improved properties as well as other advantages. Therefore, in the coating industry, there is still a need for improved coating compositions that provide improved pigment incorporation, improved shelf life for the colorant(s) and coating(s), increased recycling of packaging (more environmentally friendly), reduced clean-up of liquid colorants and packaging materials (more environmentally friendly), and ease of dosing of the colorant.

### SUMMARY

The embodiments of what is described herein are not intended to be exhaustive or to limit what is provided in the claimed subject matter and disclosed in the detailed description. Rather, the embodiments are chosen and described so that others skilled in the art may appreciate and understand the principles and practices of what is provided in the claimed subject matter.

The present application relates to a colorant tablet comprising: a) at least one pigment; and b) at least one adjuvant. The pigment may be an organic pigment, and inorganic pigment, or combinations thereof. The pigment may be an insoluble pigment. In many embodiments, the pigment may be insoluble after it is added to material, wherein the material is a solvent (including water), coating, or other material. The adjuvant may be a carbonate. The adjuvant may further comprise at least one acid. The colorant tablet may be at least partially dissolved in a solvent (including water) prior to adding to a formulation or added directly to a formulation. The formulation may be a coating. A method of forming the colorant tablet is also disclosed.

Further, a composition comprising the colorant tablet is also disclosed.

To the accomplishment of the foregoing and related ends, the following description set forth certain illustrative aspects and implementations. These are indicative of a few of the various ways in which one or more aspects may be employed. Other aspects, advantages and novel features of the disclosure will become apparent from the following detailed description when considered.

### DETAILED DESCRIPTION

Aspects of what is described herein are disclosed in the following description related to specific embodiments. Alternative embodiments may be devised without departing from the scope of what is described herein. Additionally, well-known embodiments of what is described herein may not be described in detail or will be omitted so as to not obscure the relevant details of what is described herein. Further, to facilitate an understanding of the description, discussion of several terms used herein follows.

As used herein, the word “exemplary” means “serving as an example, instance, or illustration.” The embodiments described herein are not limiting, but rather exemplary only. It should be understood that the described embodiments are not necessarily to be construed as preferred or advantageous over other embodiments. Moreover, the term “embodiment(s)” does not require that all embodiments include the discussed feature, advantage, or mode of operation.

The present disclosure relates generally to a colorant tablet that provide advantageous improvements over current pigment additions in various compositions. It has been discovered that a colorant tablet comprising: a) at least one pigment and b) at least one adjuvant may provide an improved delivery and release of at least one pigment into various compositions. Although the term “colorant tablet” is used herein, the form of the colorant tablet may be referred to as colorant tablet, colorant pill, colorant ball, colorant caplet, colorant bolus, colorant pod, pigment tablet, pigment pellet, pigment pill, pigment ball, pigment caplet, pigment bolus, pigment pod, solid pigment preparation, and the like may be used. Generally, the term colorant tablet may be understood as at least a partially dried mass of pigment. In many embodiments, the colorant tablet is less than 5% total moisture content by weight as calculated by adding the water contribution of each ingredient based on loss on drying or by Karl Fischer coulometric titrator data. In other embodiments, the colorant tablet can, for example, be less than 4% total moisture by weight, less than 3% total moisture by weight, less than 2% total moisture by weight, less than 1.5% total moisture by weight, less than 1% total moisture by weight, less than 0.5% total moisture by weight, less than 0.25% total moisture by weight, and less than 0.10% total moisture by weight. In some embodiments, the colorant tablet may have a specified and uniform shape. In other embodiments, the colorant tablet is three-dimensional and may have an unspecified shape. In many embodiments, the colorant tablet has a consistent weight between colorant tablets. In one embodiment, the colorant tablet has at least one side that is round. In another embodiment, the colorant tablet has at least one side that is oval. In yet another embodiment, the colorant tablet has at least one side that is a quadrilateral. In some embodiments, the colorant tablet has distinct edges and corners. In other embodiments, the colorant tablet has rounded edges and corners. In many embodiments, the colorant tablet may be a specified size or weight. In some embodiments, the colorant tablet may range from 5 mm to 200 mm. In a particular embodiment, the colorant tablet may range from 30 mm to 100 mm. Larger and smaller colorant tablet sizes are contemplated.

In some embodiments, the colorant tablet may be cut or split to provide a smaller portion of a colorant tablet. The colorant tablet may be cut or split by hand, or it may be cut or split by machine or tool.

In many embodiments, at least one pigment of the colorant tablet comprises organic pigments, inorganic pigments, or combinations thereof. In one embodiment, at least one pigment is a pigment dispersion.

In some embodiments, at least one pigment is an organic pigment. In another embodiment, at least one pigment is an inorganic pigment.

In some embodiments, at least one pigment is an effects pigment. In some embodiments, the effect pigment is at least one metallic pigment, at least one pearlescent pigment, or combinations thereof.

In some embodiments, the organic pigment is carbon black, perylene black, organic colorants, organic dyes, or combinations thereof. In some embodiments, the organic pigment is phthalocyanine blue, perylene black, isoindolinone yellow, quinacridone violet, pigment red 254, perylene red, benzimidazolone brown, or combinations thereof. In some embodiments, the organic pigment is a non-metallic pigment. In other embodiments, the organic pigment may have metallic portions. In one embodiment, the organic pigment is a pigment dispersion. In another embodiment, the organic pigment is a paste.

In other embodiments, at least one pigment is an inorganic pigment. In some embodiments, the inorganic pigment is titanium dioxide, zinc oxide, aluminum silicate, magnesium silicate, silica, barium sulfate, calcium sulfate, zinc chromate, calcium molybdate, strontium molybdate, zinc molybdate, zinc phosphate, zinc powder, copper powder, aluminum powder, zinc sulfide, cadmium sulfide, pearlized pigments (e.g., mica and mica-based pigments), china clay, diatomaceous silica, inorganic colorants, inorganic dyes, or combinations thereof. In some embodiments, the inorganic pigment is a non-metallic pigment. In other embodiments, the inorganic pigment is metallic. In one embodiment, the inorganic pigment is a pigment dispersion. In another embodiment, the inorganic pigment is a paste.

In many embodiments, at least one pigment may be an insoluble pigment. In many embodiments, at least one pigment may be at least partially insoluble. In many embodiments, the pigment may be at least partially insoluble after it is added to a formulation, wherein the formulation is a solvent (including water), coating, or other material. Because of the insolubility of the pigment, it would typically be difficult to incorporate the pigment into a formulation like a coating or other material. Although mixing or shaking may improve the incorporation of an insoluble pigment or a partially insoluble pigment, the use of effervescents in the incorporation of an insoluble pigment may improve the dispersion of these pigments. In some embodiments, at least one pigment may be insoluble in a solvent, wherein the solvent is water, acetone, isopropyl alcohol, benzene, toluene, xylene, ethylbenzene, butyl acetate, methyl ethyl ketone, aromatic napthas, hexane, heptane, mineral spirits, glycol ethers, esters, ethers, alcohols, other coalescent solvents, or combinations thereof. In other embodiments, at least one pigment may be partially insoluble in a solvent, wherein the solvent is water, acetone, isopropyl alcohol, benzene, toluene, xylene, ethylbenzene, butyl acetate, methyl ethyl ketone, aromatic napthas, hexane, heptane, mineral spirits, glycol ethers, esters, ethers, alcohols, other coalescent solvents, or combinations thereof. Other solvents are also contemplated.

In many embodiments, the pigment is less than 100 μm. In some embodiments, at least one pigment can, for example, be less than 90 μm, less than 80 μm, less than 75 μm, less than 70 μm, less than 60 μm, less than 50 μm, less than 40 μm, less than 30 μm, less than 20 μm, less than 10 μm, and less than 5 μm. Pigments larger than 100 μm are also contemplated.

In many embodiments, the adjuvant comprises at least one carbonate. In some embodiments, at least one carbonate comprises sodium bicarbonate, potassium bicarbonate, cesium bicarbonate, magnesium bicarbonate, calcium carbonate, calcium bicarbonate, ammonium carbonate, ammonium bicarbonate, zinc carbonate, magnesium carbonate, bismuth carbonate, sodium carbonate, potassium carbonate, cesium carbonate, carbonic acid, or combinations thereof. In many embodiments, the carbonate is a bicarbonate. In several embodiments, the carbonate is a subcarbonate. In one embodiment, the subcarbonate is bismuth subcarbonate, Other carbonates are contemplated.

In many embodiments, the adjuvant further comprises at least one acid. In some embodiments, at least one acid comprises: oxalic acid, citric acid, maleic acid, fumaric acid, glycolic acid, lactic acid, sulphamic acid, sulfonic acid, phosphonic acid, tartaric acid, benzoic acid, boric acid, formic acid, acetic acid, sulphuric acid, phosphoric acid, sodium dihydrogen phosphate, hydrochloride salt, ammonium chloride salt, or combinations thereof. Other acids are also contemplated. In one embodiment, at least one acid is a solid acid. In one embodiment, at least one acid is a liquid acid. In many embodiments, at least one acid has a pH between 1.0 and 6.5 as measured by ISO 15528:2020.

In some embodiments for preparing the colorant tablet, at least one adjuvant comprising at least one carbonate may be added to at least one pigment. With the reaction of at least one carbonate which is then subjected to an intermediate solution comprising at least one acid, the colorant tablet may be dissolved in an aqueous media. The intermediate solution may also comprise at least one solvent. The solvent may comprise water, acetone, isopropyl alcohol, benzene, toluene, xylene, ethylbenzene, butyl acetate, methyl ethyl ketone, aromatic napthas, hexane, heptane, mineral spirits, glycol ethers, esters, ethers, alcohols, other coalescent solvents, or combinations thereof. In many embodiments, the intermediate solution may also comprise at least one surfactant, dispersant, stabilizing agent, pH control agent, defoamer, adhesion promoter, thickener or rheology modifier, or combinations thereof. In one embodiment, the intermediate solution may comprise a biocide, a mildewcide, or combinations thereof. The colorant tablet disclosed herein is an effervescent composition since it will completely dissolve or substantially dissolve in the aqueous media with the reaction of at least one carbonate and at least one acid (from the intermediate solution). In some embodiments, the aqueous media is a coating. To use the colorant tablets described herein, the stoichiometry between the carbonate and the acid may be considered for optimizing the effervescent behavior and dispersion of the colorant tablet.

In other embodiments for preparing the colorant tablet, at least one preparing to add the colorant tablet, at least one adjuvant comprises: a) at least one carbonate and b) at least one acid may be added to at least one pigment. With the reaction of at least one carbonate and at least one acid, the colorant tablet may be dissolved in an aqueous media. The colorant tablet disclosed herein is an effervescent composition since it will completely dissolve or substantially dissolve in the aqueous media. In some embodiments, the aqueous media is a coating. Where the colorant tablet has an adjuvant further comprising at least one acid, the stoichiometry between the carbonate and acid may be considered for optimizing the effervescent behavior and dispersion of the colorant tablet. In still another embodiment, a colorant tablet with at least one colorant & at least one acid may be added to at least one carbonate, wherein the carbonate is in a carbonate solution. In yet another embodiment, a colorant tablet with at least one colorant & at least one carbonate may be added to at least one acid, wherein the acid is liquid or in a solution.

Further in another embodiment, the colorant tablet further comprises at least one binder. In many embodiments, at least one binder of the colorant tablet comprises at least one of the following components: a polymer, a wax, a thickener or rheology modifier, an emulsifier, an oil, a dispersant, a surface active agent (surfactant), or combinations thereof. In one embodiment, the surfactant is multifunctional. In another embodiment, the surfactant is non-ionic. In still another embodiment, the surfactant is anionic. In yet another embodiment, the surfactant is cationic.

In many embodiments, the colorant tablet further comprises at least one of the following components: water or other solvent, acid, binder or resin, surface active agent, dispersant, stabilizing agent, pH control agent, defoamer, adhesion promoter, thickener or rheology modifier, or combinations thereof. In some embodiments, at least one acid comprises: oxalic acid, citric acid, maleic acid, fumaric acid, glycolic acid, lactic acid, sulphamic acid, sulfonic acid, phosphonic acid, tartaric acid, benzoic acid, boric acid, formic acid, acetic acid, sulphuric acid, phosphoric acid, sodium dihydrogen phosphate, hydrochloride salt, ammonium chloride salt, or combinations thereof. Other acids are also contemplated.

In many embodiments, the colorant tablet is at least partially effervescent. In some embodiments, the colorant tablet is substantially effervescent. In one embodiment, the colorant tablet is completely effervescent.

In many embodiments, the colorant tablet is added to a formulation and at least partially dissolved. In other embodiments, the colorant tablet is substantially dissolved in a formulation. In one embodiment, the colorant tablet is completely dissolved in a formulation. The formulation described herein may be an aqueous material. In many embodiments, the colorant tablet is mixed or stirred to help to dissolve it into a formulation.

In some embodiments, the colorant tablet is at least partially dissolved in an intermediate solution prior to addition to the formulation. The formulation may be an aqueous material. The intermediate solution may comprise at least one solvent. The solvent may comprise water, acetone, isopropyl alcohol, benzene, toluene, xylene, ethylbenzene, butyl acetate, methyl ethyl ketone, aromatic napthas, hexane, heptane, mineral spirits, glycol ethers, esters, ethers, alcohols, other coalescent solvents, or combinations thereof. In many embodiments, the intermediate solution may also comprise at least one surfactant, dispersant, stabilizing agent, pH control agent, defoamer, adhesion promoter, thickener or rheology modifier, or combinations thereof. In one embodiment, the intermediate solution may comprise a biocide, a mildewcide, or combinations thereof. In one embodiment, the intermediate solution is basic. In another embodiment, the intermediate solution is acidic. In some embodiments, the intermediate solution comprises at least one acid. In many embodiments, at least one acid comprises: oxalic acid, citric acid, citric acid maleic acid, fumaric acid, glycolic acid, lactic acid, sulphamic acid, sulfonic acid, phosphonic acid, tartaric acid, benzoic acid, boric acid, formic acid, acetic acid, sulphuric acid, phosphoric acid, sodium dihydrogen phosphate, hydrochloride salt, ammonium chloride salt, or combinations thereof. In many embodiments, the colorant tablet is mixed or stirred to help to dissolve it into a formulation.

Also disclosed is a method of forming the colorant tablet described herein, wherein the colorant tablet comprises: a) at least one pigment; and b) at least one adjuvant. In many embodiments, the method of forming the colorant tablet may occur after mixing a) at least one pigment; b) at least one adjuvant; and c) at least one binder to form a mixture, drying the mixture, and pressing the dried mixture into a colorant tablet. In one embodiment, a method of forming the colorant tablet described herein, wherein the colorant tablet comprises: a) at least one pigment; b) at least one adjuvant; and c) at least one binder and the method of forming the colorant tablet may occur after mixing a) at least one pigment and b) at least one binder and adding a) and b) to at least one adjuvant; and then drying the mixture, and pressing the dried mixture into a colorant tablet. In many embodiments, the method further comprises the step of drying the colorant tablet after forming the pigmented composition into the colorant tablet.

In some embodiments, the colorant tablet may be encapsulated to form a colorant capsule or pigment capsule. In one embodiment, the encapsulation may occur after the dried mixture is pressed into a colorant tablet, resulting in a colorant capsule or pigment capsule. In another embodiment, the encapsulation may occur after drying the mixture comprising a) at least one pigment; and b) at least one adjuvant, where the loose mixture is packed into a colorant capsule or pigment capsule. In many embodiments, the colorant capsule or pigment capsule may comprise gelatin. In some embodiments, the colorant capsule or pigment capsule may comprise gum Arabic.

In some embodiments, the colorant tablet is formed from a pigment paste. In one embodiment, the colorant tablet is formed from a pigment paste comprising at least one pigment, and the pigment paste is dried to form the colorant tablet. When these pigment pastes undergo a drying step, a homogeneous thick paste may be formed. In one particular embodiment, these pigment pastes may be dried to remove all or most moisture such that a powdered substance is created. After the pigment paste is formed, at least one adjuvant should be added to the pigment paste. This adjuvant may be comprised of at least one carbonate. In some embodiments, the carbonate is a bicarbonate. Optionally, at least one adjuvant may comprise at least one acid. If at least one acid is added to the tablet, then the tablet should be dried to minimize any water generation.

In many embodiments, the method of forming a colorant tablet comprising the steps of: a) forming a pigment paste from at least one pigment; b) adding an adjuvant to the pigment paste, wherein the adjuvant comprises at least one carbonate and optionally an acid, to form a pigmented composition; and c) forming the pigmented composition into the colorant tablet. In some embodiments, effervescent colorant tablets that are prepared by forming a pigment paste from at least one pigment with at least one binder (e.g., waterborne emulsions or dispersions) and optionally, other additives and solvents (including water or other conventional solvents) using milling equipment to grind the pigment particles to the desired fineness. In some embodiments, forming a pigment paste from at least one pigment and further includes the addition of at least one the following components: water or other solvent, acid, binder or resin, surface active agent, dispersant, stabilizing agent, pH control agent, defoamer, adhesion promoter, thickener or rheology modifier, or combinations thereof. In some embodiments, the colorant tablets comprise at least one of the following components: water or other solvent, acid, binder or resin, surface active agent, dispersant, stabilizing agent, pH control agent, defoamer, adhesion promoter, thickener or rheology modifier, or combinations thereof.

In one embodiment, the colorant tablet comprises at least one additive. In some embodiments, at least one additive may include but is not limited to, other polymers or polymer dispersions, surfactants, dispersants, stabilizing agents, pH control agents, defoamers, biocides, mildewcides, algaecides, thickeners or rheology modifiers, leveling agents, anti-settling agents, pH buffers, corrosion inhibitors, driers, anti-skinning agents, anti-cratering agents, anti-sag agents, heat stabilizers, UV protective materials like absorbers/inhibitors (e.g., titanium dioxide, inorganic pigment, organic pigment, UV absorber, photoinitiator, hindered amine light stabilizer (HALS), polymer, or combinations thereof), antioxidants, wetting agents, flatteners and other inert pigments (such as titanium dioxide, dyes, clay, amorphous and surface treated silica, calcium carbonate, and the like, and combinations thereof), flow agents, and the like, and various combinations thereof as needed for a particular application and other performance properties.

In many embodiments, the pigment pastes undergo a drying step in which a homogeneous or substantially homogenous thick paste or alternatively, a powdery substance, is created. In one embodiment, the paste may comprise at least one acid. In some embodiments, at least one adjuvant is then added to this paste or powdery substance to form a pigmented composition. In many embodiments, the adjuvant comprises at least one carbonate and at least one acid. In other embodiments, the adjuvant comprises at least one carbonate without an acid if the acid is already in the paste. Next, in some embodiments, the pigmented composition, either as a paste or powdery substance, is formed into colored colorant tablets shapes that can be dissolved spontaneously due its effervescent nature in aqueous media (e.g., waterborne emulsions or dispersions with appropriate coating additives present (e.g., rheology modifier, dispersants, stabilizing agents, pH control agents, surface active agents and/or coalescent solvents).

In some embodiments, the method further comprises the step of milling the pigment paste prior to adding the adjuvant to the pigment paste. In yet another embodiment, the method further comprises the step of drying the pigment paste prior to adding the adjuvant to the pigment paste. Further in many embodiments, the method further comprises the step of drying the colorant tablet after forming the pigmented composition into the colorant tablet.

Also disclosed is a composition comprising the colorant tablet described herein. The colorant tablet comprising: a) at least one pigment; and b) at least one adjuvant. In many embodiments, the composition is a coating. An adjuvant may be a carbonate. The adjuvant may further comprise at least one acid.

Ultimately, the colorant tablet described herein may be an effervescent colorant tablet. In many embodiments, the colorant tablet may be shipped in boxes or bags as packaging. In other embodiments, the colorant tablet may be supplied as strips for convenience where various tablet sizes and amounts may be adjusted for use. These colorant tablets supplied as strips may be automated in processing for weight, including multiple weights needed.

Further, the use of the colorant tablet described herein may provide certain advantages over current methods of adding pigments to coatings and other materials, including but not limited to improved dispersion of the pigments into a coating. The use of the colorant tablet may also provide improved color development in a coating. For example, the manufacturing process for coatings or other materials does not require dedicated color processing steps and equipment as well as any labor involved with these steps. Instead, pigment pastes only require a drying process step followed by tablet formation (e.g., a tablet pressing). Additionally, the use of the colorant tablet described herein may provide improved pigment incorporation, improved shelf life for the colorant(s) and coating(s), increased recycling of packaging (more environmentally friendly), reduced clean-up of liquid colorants and packaging materials (more environmentally friendly), and ease of dosing of the colorant.

Additionally, the use of the colorant tablet described herein may reduce transport costs and storage space since containers of colorants or pigment mixtures are often heavier and bulkier from their packaging. Eliminating the need for these containers to hold colorants or pigment mixtures may also provide other benefits such as less waste by eliminating the container, extending the shelf-life, eliminating hardening or skinning in the container, eliminating residual colorants in the container, lowering the risk of potential contamination with other materials, reducing or eliminating biocides and mildewcides, and lessening bacterial spoilage. Further, labeling may be simplified when colorant tablets are used due to the reduction or elimination of harmful organic solvents, biocides and mildewcides.

In many embodiments, the colorant tablet described herein may have a Volatile Organic Compound (VOC) as measured by ASTM D3960 of less than 0.83 lb./gallon (about 100 g/l). In many embodiments, the colorant tablet described herein may be used in a coating that has a Volatile Organic Compound (VOC) as measured by ASTM D3960 of less than 0.42 lb./gallon (about 50 g/l). In some embodiments, the colorant tablet described herein may be used in a coating that has a Volatile Organic Compound (VOC) as measured by ASTM D3960 of less than 0.21 lb./gallon (about 25 g/l). In some embodiments, the colorant tablet described herein may be used in a coating that has a Volatile Organic Compound (VOC) as measured by ASTM D3960 of less than 0.05 lb./gallon (about 5 g/l). In other embodiments, the colorant tablet has a Volatile Organic Compound (VOC) as measured by ASTM D3960 of 0 lb./gallon (0 g/l). In one embodiment, the colorant tablet described herein has substantially no volatile organic compounds (VOC).

In many embodiments, the coating containing the colorant tablet described herein may have a Volatile Organic Compound (VOC) as measured by ASTM D3960 of less than 0.83 lb./gallon (about 100 g/l). In many embodiments, the coating containing the colorant tablet described herein may be used in a coating that has a Volatile Organic Compound (VOC) as measured by ASTM D3960 of less than 0.42 lb./gallon (about 50 g/l). In some embodiments, the coating containing the colorant tablet described herein may be used in a coating that has a Volatile Organic Compound (VOC) as measured by ASTM D3960 of less than 0.21 lb./gallon (about 25 g/l). In some embodiments, the coating containing the colorant tablet described herein may be used in a coating that has a Volatile Organic Compound (VOC) as measured by ASTM D3960 of less than 0.05 lb./gallon (about 5 g/l). In other embodiments, the coating containing the colorant tablet has a Volatile Organic Compound (VOC) as measured by ASTM D3960 of 0 lb./gallon (0 g/l). In one embodiment, the waterborne coating containing the colorant tablet has substantially no volatile organic compounds (VOC).

### Experimental Results

Colorant tablets were prepared from a homogeneous powder mixture comprising pigment and combinations with citric acid and/or sodium bicarbonate. Although various pigments, acids, and carbonates may be used for the colorant tablet, the specific ones listed in Table 1 were chosen for comparison purposes. The black pigment used was a carbon black with high jetness and an ability to be used in waterborne formulations.

Colorant tablets (Examples #0-4 and A only) were prepared by pressing pigment powder or powder mixtures with 15t of pressure into a round shaped tablet with a diameter of 40 mm using a Fluxana PR-25N Tablet Press. References 1 and 2 provided traditional means of pigment addition in a powder form.

Either the pigment itself (References 1 and 2) or the colorant tablets (Examples #0-4 only) test samples were added to an intermediate solution with demineralized water and options for surfactant, citric acid, and sodium bicarbonate (as noted in Table 1 for each test sample). Example A was prepared as a tablet and added directly into the letdown. No intermediate solution was used in Example A.

The colorant (either as pigments alone like References 1 and 2 or as a tablet like Examples #0-4 and A only) were added to a letdown formulation composing binder, solvent, and additives only (but no pigments) yielding a toner formulation by using two different methods of colorant addition. Specifically, the letdown formulation had a solid content of 15 wt. % and was comprised of a waterborne alkali-swellable acrylic copolymer dispersion, butyl glycol, wetting agent, neutralizing agent, and demineralized water. Pigment was dosed to the abovementioned letdown formulation either indirect via an intermediate solution prepared from pigment powder (References 1 and 2) or a colorant tablet (Examples #0-4). In Example A, a colorant tablet was directly added to the letdown formulation. The resulting toner formulations were allowed to mix for a certain mixing time (15-45 minutes as noted in Table 1) at room temperature with or without additional mechanical stirring using a digital lab mixer (also noted in Table 1). Next the pH of these black toner formulations was determined according to ASTM E70-24.

TABLE 1
Formulations Tested

| | REF-1 | REF-2 | #0 | #1 | #2 | #3 | #4 | A |
|---|---|---|---|---|---|---|---|---|
| COLORANT | | | | | | | | |
| Black pigment | 2.70 | 2.70 | 2.70 | 2.70 | 2.70 | 2.70 | 2.70 | 2.70 |
| (gr.) | | | | | | | | |
| Citric acid (gr.) | | | | 3.00 | 1.00 | | 3.00 | 3.00 |
| Sodium | | | | 3.00 | 1.00 | 3.00 | | 3.00 |
| bicarbonate | | | | | | | | |
| (gr.) | | | | | | | | |
| TABLET | NO | NO | YES | YES | YES | YES | YES | YES |
| | (powder) | (powder) | | | | | | |
| Demineralized | 74.9 | 68.9 | 74.9 | 68.9 | 72.9 | 68.9 | 68.9 | |
| water (gr.) | | | | | | | | |
| Nonionic | 0.40 | 0.40 | 0.40 | 0.40 | 0.40 | 0.40 | 0.40 | |
| Multifunctional | | | | | | | | |
| Surfactant (gr.) | | | | | | | | |
| Citric acid (gr.) | | 3.00 | | | | 3.00 | | |
| Sodium | | 3.00 | | | | | 3.00 | |
| bicarbonate | | | | | | | | |
| (gr.) | | | | | | | | |
| BLACK TONER | | | | | | | | |
| PREPARATION | | | | | | | | |
| Colorant (gr.) | 11.07 | 11.07 | 11.07 | 11.07 | 11.07 | 11.07 | 11.07 | 8.70 |
| Letdown (gr.) | 88.93 | 88.93 | 88.93 | 88.93 | 88.93 | 88.93 | 88.93 | 82.93 |
| mixing time | 15 | 15 | 15 | 15 | 15 | 30 | 30 | 45 |
| (min) | | | | | | | | |
| additional | YES | YES | YES | NO | NO | NO | NO | NO |
| stirring | | | | | | | | |
| Toner pH | 7.64 | 6.30 | 7.67 | 6.34 | 6.86 | 6.32 | 6.77 | 5.65 |
| BASECOAT | | | | | | | | |
| DRAWDOWN | | | | | | | | |
| Color | 10:20 | 10:20 | 10:20 | 10:20 | 10:20 | 10:20 | 10:20 | 10:20 |
| reduction | black:white | black:white | black:white | black:white | black:white | black:white | black:white | black:white |
| | mixture | mixture | mixture | mixture | mixture | mixture | mixture | mixture |
| Color strength | 100.00 | 105.66 | n.d. | 101.61 | 102.72 | 102.12 | 89.07 | n.d. |
| (%) | | | | | | | | |
| Gloss 60° | 72.4 | 72.9 | 72.4 | 70.2 | 70.2 | 73.4 | 72.9 | 41.6 |
| Visual film | NO | NO | Grit, tablet | NO | NO | NO | Grit, tablet | Foam |
| defects and | | | not fully | | | | not fully | |
| remarks | | | dissolved | | | | dissolved | |

The obtained waterborne toner formulations in Table 1 were then mixed with a white pigmented toner in a 10:20 mixing ratio and were applied next on Leneta cards with an automatic drawdown applicator (Sheen automatic drawdown applicator 1133N using a 200 μm bar with 50 mm/sec speed). These basecoat films were dried for 30 min. at 50° C. The white pigmented toner in the letdown had a solid content of 15 wt. % and was comprised of a waterborne alkali-swellable acrylic copolymer dispersion, butyl glycol, wetting agent, neutralizing agent, rutile titanium dioxide (TiO₂) pigment, and demineralized water.

The samples were then tested for color strength and gloss. Color strength was determined by a multi-angle spectrophotometer (BYK-mac i™ instrument from BYK-Instruments GmbH) using the CIELAB color scale in which the measurement is based on L* (lightness), a* (red-green axis), and b* (blue-yellow) values according to ASTM D2244. Color strength is reported in comparison to the 100% control. In Table 1, the term “n.d.” means that the test results could not be determined.

Gloss differences were also tested using ISO 2813 for gloss measurement of specular gloss of non-metallic paint films at 60° angle with a micro-TRI-gloss™ instrument from BYK-Instruments. The samples were also tested for grit and visual film defects. The coating was either positive where grit could be visually detected or negative where no grit could be seen. Foam, if present, was also noted.

From the data in Table 1, all samples used the same black pigment. References 1 and 2 were not formed into tablets and were used as comparative examples as to how colorant tablet-based formulations would compare to conventional methods. Reference 2 had the addition of citric acid and sodium bicarbonate. Examples #0-4 and Example A were all formed into tablets. In Examples 1, 2 and 4, the colorant tablet itself comprised acid, specifically citric acid. Sodium bicarbonate was chosen as the carbonate in the colorant tablet for Examples #1-3 and Example A. Example 2 had lower amounts of citric acid and sodium bicarbonate over Example 1. In Example 0, no acid nor carbonate was used in the tablet. Example 3 contained carbonate in the tablet, but acid was added to the intermediate solution instead. Example A the colorant tablet was added directly into the letdown formulation without using a surfactant containing intermediate solution.

Although both citric acid and sodium bicarbonate were also added to Reference 2, the pH was reduced, and the color strength increased slightly over Reference 1. Even through the color strength was stronger for Reference 2, it is speculated that color adjustments could be made to adjust this color strength in Reference 2. In Example 0 the colorant tablet (pigment only without citric acid or sodium bicarbonate) was not fully dissolved and had a very low color strength compared to Reference 1. Unlike Example 0, Examples 1-3 achieved a more similar color strength and gloss to Reference 1 without additional stirring. Further, Examples 1-3 did not have visual defects. Example 4 did not have a carbonate in the tablet, which resulted in a significantly lower color strength and visual defects in the film. Example 4 had also grit in the film as the tablet did not fully dissolve.

Example A was also prepared using a colorant tablet but added directly to the toner without any additional water, and surfactant. Although the colorant tablet successfully dissolved, Example A resulted in a very foamy mixture that could not be accurately read for color strength, and the gloss was significantly different from the other formulations with similar materials. Even though no grit was detected in Example A, the formulation for Example A may need to be optimized beyond the test parameters provided in Table 1 to reduce the foam.

### EMBODIMENTS

The following embodiments are contemplated. All combinations of features and embodiments are contemplated.
Embodiment 1: A colorant tablet comprising: a) at least one pigment; and b) at least one adjuvant.
Embodiment 2: An embodiment of Embodiment 1, wherein the pigment comprises organic pigments, inorganic pigments, or combinations thereof.
Embodiment 3: An embodiment of any of Embodiments 1-2, wherein the pigment is insoluble in a solvent, wherein the solvent is water, acetone, isopropyl alcohol, benzene, toluene, xylene, ethylbenzene, butyl acetate, methyl ethyl ketone, aromatic napthas, hexane, heptane, mineral spirits, glycol ethers, esters, ethers, alcohols, other coalescent solvents, or combinations thereof.
Embodiment 4: An embodiment of any of Embodiments 1-3, wherein the adjuvant comprises at least one carbonate.
Embodiment 5: An embodiment of Embodiment 4, wherein at least one carbonate comprises sodium bicarbonate, potassium bicarbonate, cesium bicarbonate, magnesium bicarbonate, calcium carbonate, calcium bicarbonate, ammonium carbonate, ammonium bicarbonate, zinc carbonate, magnesium carbonate, bismuth carbonate, sodium carbonate, potassium carbonate, cesium carbonate, carbonic acid, or combinations thereof.
Embodiment 6: An embodiment of any of Embodiments 1-5, wherein the adjuvant further comprises at least one acid.
Embodiment 7: An embodiment of Embodiment 6, wherein at least one acid comprises: oxalic acid, citric acid, maleic acid, fumaric acid, glycolic acid, lactic acid, sulphamic acid, sulfonic acid, phosphonic acid, tartaric acid, benzoic acid, boric acid, formic acid, acetic acid, sulphuric acid, phosphoric acid, sodium dihydrogen phosphate, hydrochloride salt, ammonium chloride salt, or combinations thereof.
Embodiment 8: An embodiment of any of Embodiments 1-7 further comprising at least one binder.
Embodiment 9: An embodiment of Embodiment 8, wherein at least one binder comprises: a polymer, a wax, a thickener or rheology modifier, an emulsifier, an oil, a dispersant, a stabilizing agent, a pH control agent, or combinations thereof.
Embodiment 10: An embodiment of any of Embodiments 1-9, wherein the colorant tablet further comprises at least one: water or other solvent, acid, polymer surface active agent, dispersant, stabilizing agent, pH control agent, defoamer, adhesion promoter, thickener or rheology modifier, or combinations thereof.
Embodiment 11: An embodiment of any of Embodiments 1-10, wherein the colorant tablet is formed from a pigment paste.
Embodiment 12: An embodiment of any of Embodiments 1-11, wherein the colorant tablet is at least partially effervescent.
Embodiment 13: A method of dissolving the colorant tablet, wherein the colorant tablet of any of Embodiments is added to a formulation and at least partially dissolved.
Embodiment 14: An embodiment of Embodiment 13, wherein the colorant tablet is at least partially dissolved in an intermediate solution prior to addition to the formulation.
Embodiment 15: An embodiment of Embodiment 14, wherein the intermediate solution comprises at least one acid.
Embodiment 16: A method of forming the colorant tablet of any of Embodiments 1-12.
Embodiment 16: An embodiment of Embodiment 15, wherein the colorant tablet is formed from a pigment paste comprising at least one pigment and the pigment paste is dried to form the colorant tablet.
Embodiment 17: A method of forming a colorant tablet comprising the steps of: a) forming a pigment paste from at least one pigment; b) adding an adjuvant to the pigment paste, wherein the adjuvant comprises at least one carbonate and optionally an acid, to form a pigmented composition; and c) forming the pigmented composition into the colorant tablet.
Embodiment 18: An embodiment of Embodiments 17, wherein the pigment paste further includes the addition of at least one: water or other solvent, acid, binder or resin, surface active agent, dispersant, stabilizing agent, pH control agent, defoamer, adhesion promoter, thickener, or rheology modifier, or combinations thereof.
Embodiment 19: An embodiment of any of Embodiments 17-18 further comprises the step of milling the pigment paste prior to adding the adjuvant to the pigment paste.
Embodiment 20: An embodiment of any of Embodiments 17-19 further comprises the step of drying the pigment paste prior to adding the adjuvant to the pigment paste.
Embodiment 21: An embodiment of any of Embodiments 17-20 further comprising the step of drying the colorant tablet after forming the pigmented composition into the colorant tablet.

What has been described above includes examples of the claimed subject matter. All details and any described modifications in connection with the Background and Detailed Description are within the spirit and scope of the claimed subject matter will be readily apparent to those of skill in the art. In addition, it should be understood that aspects of the claimed subject matter and portions of various embodiments and various features recited below and/or in the appended claims may be combined or interchanged either in whole or in part. In the foregoing descriptions of the various embodiments, those embodiments which refer to another embodiment may be appropriately combined with other embodiments as will be appreciated by one of skill in the art. Furthermore, those of ordinary skill in the art will appreciate that the foregoing description is by way of example only, and is not intended to limit the claimed subject matter, realizing that many further combinations and permutations of the claimed subject matter are possible. It is, of course, not possible to describe every conceivable combination of components or methodologies for purposes of describing the claimed subject matter, but one of ordinary skill in the art may recognize. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A colorant tablet comprising:
at least one pigment; and
at least one adjuvant.

2. The colorant tablet of claim 1, wherein the pigment comprises organic pigments, inorganic pigments, or combinations thereof.

3. The colorant tablet of claim 1, wherein the pigment is insoluble in a solvent, wherein the solvent is water, acetone, isopropyl alcohol, benzene, toluene, xylene, ethylbenzene, butyl acetate, methyl ethyl ketone, aromatic napthas, hexane, heptane, mineral spirits, glycol ethers, esters, ethers, alcohols, other coalescent solvents, or combinations thereof.

4. The colorant tablet of claim 1, wherein the adjuvant comprises at least one carbonate.

5. The colorant tablet of claim 4, wherein at least one carbonate comprises sodium bicarbonate, potassium bicarbonate, cesium bicarbonate, magnesium bicarbonate, calcium carbonate, calcium bicarbonate, ammonium carbonate, ammonium bicarbonate, zinc carbonate, magnesium carbonate, bismuth carbonate, sodium carbonate, potassium carbonate, cesium carbonate, carbonic acid, or combinations thereof.

6. The colorant tablet of claim 1, wherein the adjuvant further comprises at least one acid.

7. The colorant tablet of claim 6, wherein at least one acid comprises: oxalic acid, citric acid, maleic acid, fumaric acid, glycolic acid, lactic acid, sulphamic acid, sulfonic acid, phosphonic acid, tartaric acid, benzoic acid, boric acid, formic acid, acetic acid, sulphuric acid, phosphoric acid, sodium dihydrogen phosphate, hydrochloride salt, ammonium chloride salt, or combinations thereof.

8. The colorant tablet of claim 1 further comprising at least one binder.

9. The colorant tablet of claim 8, wherein at least one binder comprises: a polymer, a wax, a thickener or rheology modifier, an emulsifier, an oil, a dispersant, a stabilizing agent, pH control agent, or combinations thereof.

10. The colorant tablet of claim 1, wherein the colorant tablet further comprises at least one: water or other solvent, acid, polymer, surfactant, dispersant, stabilizing agent, pH control agent, defoamer, adhesion promoter, thickener or rheology modifier, or combinations thereof.

11. The colorant tablet of claim 1, wherein the colorant tablet is formed from a pigment paste.

12. The colorant tablet of claim 1, wherein the colorant tablet is at least partially effervescent.

13. A method of dissolving the colorant tablet of claim 1, wherein the colorant tablet is added to a formulation and at least partially dissolved.

14. The method of claim 13, wherein the colorant tablet is at least partially dissolved in an intermediate solution prior to addition to the formulation.

15. The method of claim 14, wherein the intermediate solution comprises at least one acid.

16. A method of forming the colorant tablet of claim 1.

17. The method of claim 16, wherein the colorant tablet is formed from a pigment paste comprising at least one pigment and the pigment paste is dried to form the colorant tablet.

18. A method of forming a colorant tablet comprising the steps of:
forming a pigment paste from at least one pigment;
adding an adjuvant to the pigment paste, wherein the adjuvant comprises at least one carbonate and optionally an acid, to form a pigmented composition; and
forming the pigmented composition into the colorant tablet.

19. The method of claim 18, wherein the pigment paste further includes the addition of at least one: water or other solvent, acid, binder or resin, surfactant, dispersant, stabilizing agent, pH control agents, defoamer, adhesion promoter, thickener or rheology modifier, or combinations thereof.

20. The method of claim 1 further comprising the step of milling the pigment paste prior to adding the adjuvant to the pigment paste.

21. The method of claim 1 further comprising the step of drying the pigment paste prior to adding the adjuvant to the pigment paste.

22. The method of claim 1 further comprising the step of drying the colorant tablet after forming the pigmented composition into the colorant tablet.
